(19) United States
(12) Patent Application Publication
(10) Pub. No.: US 2004/0140317 A1
(43) Pub. Date: Jul. 22, 2004

(54) Vending machine

(76) Inventor: Yehuda Forte, Yavne (IL)

Correspondence Address: NATH & ASSOCIATES PLLC, Sixth Floor, 1030 15th Street, N.W., Washington, DC, 20005, US

(21) Appl. No.: 10/667,153

(22) Filed: Sep. 22, 2003

(30) Foreign Application Priority Data
Jan. 20, 2003 (IL) 154054

(51) Int. Cl. B65H 3/44; G07F 11/00; B65G 59/00

(52) U.S. Cl. 221/123; 221/130; 221/131

(57) ABSTRACT

A vending machine comprising a cabinet having a front wall fitted with a dispensing opening, a plurality of conveyer racks parallely disposed within the cabinet, each for storing and conveying a plurality of boxes and each extending between a rear end adjacent a rear wall of the cabinet and a front end facing the front wall, and an elevator assembly vertically displaceable along a path extending within the cabinet between the front ends of the conveyer racks and the front wall and being displaceable between a plurality of collecting stations adjacent each front end and a vending station adjoining the dispensing opening.

### FIELD OF THE INVENTION

The present invention generally relates to vending machines for vending packaged goods such as beverages. More specifically, the present invention is concerned with a vending machine of the type comprising a cabinet fitted with a plurality of shelves carrying goods, and an elevator assembly for transferring goods to a goods delivery port. In particular the present invention is directed to a box vending machine.

The term box as used hereinafter in the specification and claims, refers to a container or package, e.g. made of cardboard (where it is often referred to as a carton) or other suitable material e.g. shrink plastic wrap, for packaging a plurality of beverage bottles or cans, etc. Often, a box of the concerned type is a rectangular case. However, according to a different form, a box according to its broad meaning in the present specification and claims may also be a soft pack holding the beverage, e.g. a gallon of water received within a can of soft material.

### BACKGROUND OF THE INVENTION

A variety of vending machines are available and many patents deal with different types of vending machines, such as for vending of non-food stuffs or food stuffs, the latter having a large diversity of types, e.g. for vending fresh food (sandwiches, cakes, etc.), other food stuffs e.g. snacks, and sweets, and beverage vending machines which fall into two main categories, namely freshly made drinks e.g. juices, hot drinks (coffee, hot chocolate, soups, etc.) or canned or bottled beverages. The present invention deals with vending machines of the latter type.

U.S. Pat. No. 4,976,441 discloses a vending machine including a cabinet, a first merchandise carrying member disposed within said cabinet having a plurality of vertically aligned conveyer racks and a vertically extending elevator disposed within the cabinet. The elevator has a movable bucket. The machine also includes a second merchandise carrying member disposed within the cabinet, disposed under the plurality of conveyer racks and including at least one serpentine rack. A conveyer mechanism is disposed under the at least one serpentine rack for receiving merchandise therefrom and for carrying this merchandise to the bucket of the elevator.

U.S. Pat. No. 5,881,911 discloses a vending machine provided with a cabinet having a plurality of slanted shelves. These shelves feed to an elevator which can be located in the center of the vending machine, to one side of the vending machine or at the rear of the vending machine. Packaged beverages will feed by gravity from the shelves to the elevator and then be delivered to the delivery port in the face of the cabinet, which is at a convenient height for the consumer. The shelves in the cabinet are readily reconfigurable such that their positioning within the cabinet can be easily altered. Gravity release devices are provided on each shelf for discharging the packaged beverages to the elevator. These gravity release devices are powered by an activation device on the elevator. Thus, electrical connections or the like are unnecessary for the individual shelves.

However, both the above-mentioned patents are concerned with vending machines solely for vending unitary beverage containers, i.e. cans or bottles. Such machines are not fitted for vending boxes owing to the significant size and in particular weight of a box.

It is thus an object of the present invention to provide a vending machine for boxes, as defined hereinabove, in particular, though not restricted to, beverage packages such as, for example, can packs (e.g. holding 6 or more cans) or bottle packages (e.g. holding 6, 8, 12, etc. bottles, each bottle containing 1, 1½ or 2 liters or other volumes as may be desired), etc.

### SUMMARY OF THE INVENTION

According to the present invention there is provided a vending machine comprising:

a cabinet having a front wall fitted with a dispensing opening;

a plurality of conveyer racks, parallely disposed within the cabinet, each for storing and conveying a plurality of boxes; each conveyer rack extending between a rear end adjacent a rear wall of the cabinet and a front end facing said front wall; and

an elevator assembly vertically displaceable along a path extending within the cabinet between the front ends of the conveyer racks and the front wall and being displaceable between a plurality of collecting stations adjacent each said front end and a vending station adjoining the dispensing opening.

According to an embodiment of the invention, the conveyer racks are fitted with a box-displacing arrangement for displacing boxes from the rear end toward the front end thereof, and by a further embodiment the box displacing arrangement comprises a plurality of free-rolling members disposed along the conveyer rack and where the conveyer rack is inclined to facilitate gravitational displacement of the boxes toward the front end of the conveyer rack. According to one particular design, the free rollers are a plurality of parallely extending roller members, their axis transversing the conveyer rack at a right angle.

According to a convenient arrangement of the invention, the conveyer racks are accessed for loading through a loading door at a rear portion of the cabinet and by one particular design the conveyer racks are inclined such that boxes are displaceable over the conveyer racks by gravity force only. However, motorized displacement of the boxes is an embodiment as well.

In accordance with a different embodiment of the invention, the conveyor racks are essentially leveled and thus, each conveyor rack is fitted with a motor for displacing the boxes from the rear end thereof towards the front end. In accordance with still another embodiment of the invention, there is a common motor engagable in turn with any duty conveyor rack by suitable transmission arrangements, e.g. a linked chain, a transmission gear, etc. Accordingly, suitable control arrangements are provided.

By still another embodiment of the invention, one or more of the conveyer racks are fitted with lateral support members to prevent lateral displacement of the boxes over the rack and the distance between opposite support members is modular for receiving boxes of different sizes.

According to a particular design of the invention, each conveyer rack is fitted at its front end with a toggle assembly to prohibit displacement of a duty box from the conveyer rack. The toggle assembly is fitted for releasing the duty box and simultaneously arresting the next in line box. By one arrangement, the toggle assembly is activated by an activating member associated with the elevator.

According to the invention, the elevator is fitted with an elevator conveyer rack for displacing a box between a rear end and a front end thereof and by one design the elevator conveyer rack is activated by a motor and the elevator is fitted with an elevator conveyer rack comprising a lever for activating a toggle assembly associated with each conveyer rack, to control displacement of a duty box from the conveyer rack. The elevator conveyer rack is fitted for traveling in an opposite direction, to allow for the lever to activate the toggle member in two operative sequences, one to facilitate transfer of a duty box from the conveyer rack to the elevator and arrest the next box at a stand by location over the conveyer rack; and the second to facilitate displacing of said next box from said standby location to a duty box location at the front end of the conveyer rack.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 is a front isometric view of a vending machine according to the present invention;

FIG. 2A is a schematic side view of the vending machine, after removing a side wall thereof;

FIG. 2B is a schematic front view of the vending machine after removing a front wall thereof;

FIGS. 3A to 3E are schematic representations of the portion marked III in FIG. 2A, illustrating a box-displacement assembly, at several consecutive stages of displacing a box from a conveyor rack to an elevator of the vending machine;

FIGS. 4A to 4E are schematic representations illustrating a box-displacement assembly in accordance with a different embodiment of the present invention, shown in several consecutive stages.

FIG. 5A is an isometric view of a conveyer rack according to an embodiment of the present invention wherein lateral support members are provided;

FIG. 5B is an elevation of the portion marked V in FIG. 5A;

FIG. 6A is a schematic side view of a vending machine in accordance with another embodiment of the invention, after removing a side wall thereof; and

FIG. 6B is a schematic front view after removing a front wall thereof.

### DETAILED DESCRIPTION OF THE INVENTION

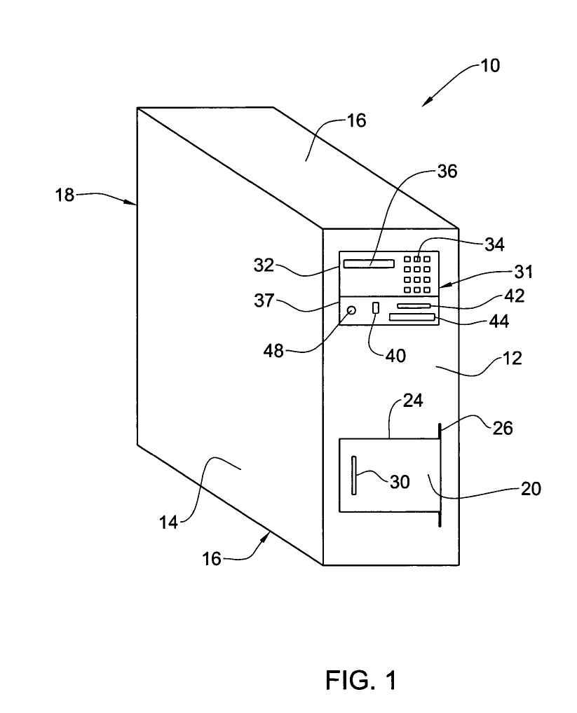

Attention is first directed to FIG. 1 of the drawings illustrating a vending machine in accordance with the present invention generally designated 10. The vending machine 10 is a relatively narrow rectangular construction being a cabinet formed with a front wall 12, side walls 14, top and bottom walls 16 and a rear wall 18.

The front wall 12 is fitted with a dispensing opening 20 normally closed by door 24 which in the present example is pivotally hinged at 26 and is swingably opened by means of handle 30. However, other forms of doors may be provided, e.g. a door pivotable about a horizontal axis which may also serve as a shelf when at the open position, a sliding door etc. Furthermore, the door 24 may be automatically displaced between its open and closed position whereby suitable activation and sensing means are provided (not shown). According to a particular design, the door 24 is formed at a height for convenient removal of a weighty box therefrom, i.e. at a height which does not require lifting the box and where minimal effort is required for carrying the box away from the machine. According to one specific design, the door 24 is formed at a height corresponding with a height of a boot of an average vehicle, so as to facilitate easy loading of the box to the vehicle.

The front wall 12 is further fitted with a user interface generally designated 31, which comprises a product selection module 32 fitted with a plurality of selection buttons 34 for a customer to select the type and amount of goods to be purchased, and a display 36 for providing the user with operating instructions, information regarding the goods, advertising, etc. The user interface further comprises a paying module 37 fitted, for example, with a coin insertion and return slot 40, credit card slot 42, bill receiving slot 44 and an operation-canceling knob 48.

Although not shown, the vending machine 10 further comprises a control unit securely received within the cabinet and being linked to the product selection module 32 and to the paying module 37, as well as to other components of the machine, e.g. conveyor racks, elevator, service door, delivery door, etc., as one can appreciate. Furthermore, the control unit may be fitted for communication with a remote control center, e.g. by wireless communication system (cellular communication system) etc. Such communication means are advantageous for updating the control center as far as consumption of goods from the vending machine, customer preferences, malfunction of the vending machine, etc. Furthermore, it is possible that a remote control center provide online customer service support whereby the vending machine would thus be fitted with a two-way speaker/microphone unit (not shown).

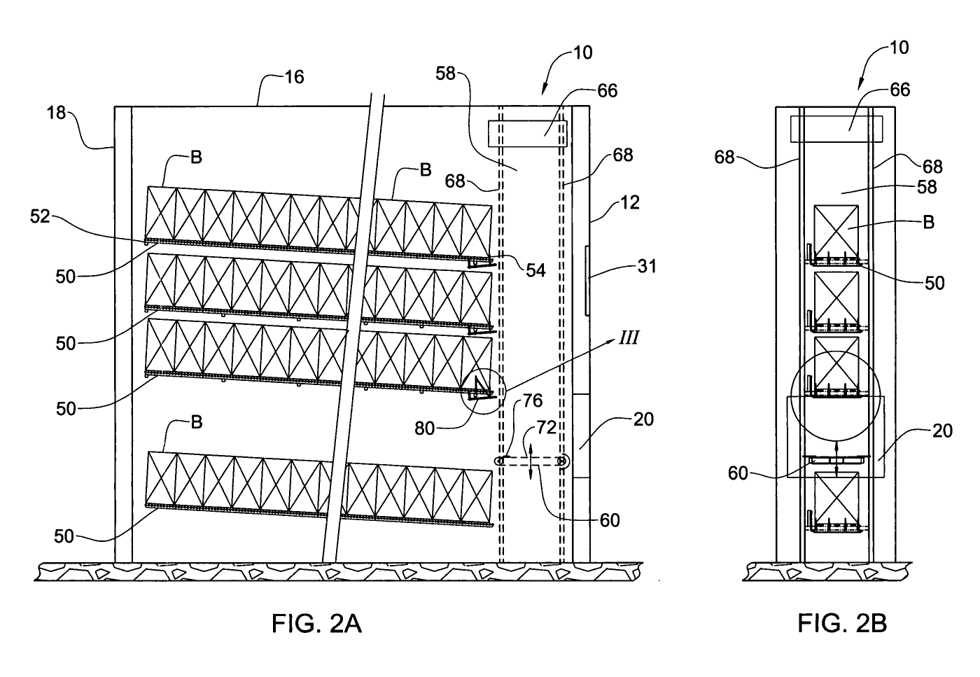

The rear wall 18 (schematically shown in FIG. 2A) is a loading door providing access to the cabinet and in particular to the plurality of conveyor racks 50 (depending on the available space, the vending machine 10 may be larger and thus comprise any practical number of conveyer racks). The conveyor racks 50 are of the so-called gravity conveyer rack type and extend from a rear end 52 towards a lower, front end 54. The front end 54 of the conveyer racks 50 are disposed adjacent an elevator shaft 58 which is the space in which elevator assembly 60 vertically displaces as will be explained hereinafter.

Each of the conveyor racks 50 is fitted with a plurality of free-rolling members disposed along the rack for displacing boxes B from a rear end 52 towards a front end 54 of the rack merely by gravity. Forms of gravity conveyors are, for example, roller conveyors (with or without a conveyor rack), wheel conveyors, ball conveyors, etc. Furthermore, in accordance with another embodiment of the invention (not shown) the conveyor racks may be motorized rather than being gravity conveyors, in which case a suitable motor is provided as well as control means for activating the conveyor and controlling operation thereof.

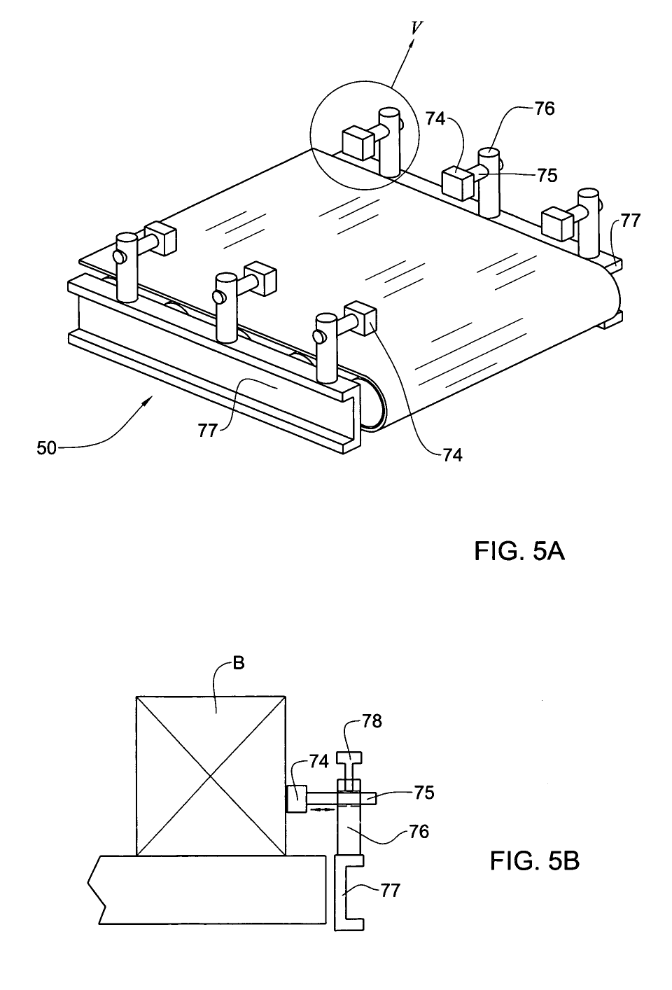

According to a specific embodiment of the present invention, as illustrated in FIGS. 5A and 5B of the drawings, at least part of the conveyor racks disposed within the cabinet of the vending machine are fitted with lateral support members 74, for preventing lateral displacement of boxes mounted on the conveyor and for correct positioning of the boxes over the rack (e.g. centering the boxes), in case boxes of smaller size are used. This may be the case, for example, when using packs of cans instead of boxes holding beverage bottles and for correct alignment of the boxes when using boxes of different sizes, e.g. boxes holding beverage bottles of 1.5 liters or 2 liters, etc. The distance between the opposite support members 74 of a particular rack is changeable, e.g. by automatic biasing members or manually, to comply with the width of particular boxes mounted on the specific rack. According to a particular arrangement as illustrated in FIGS. 5A and 5B, the support members 74 are fitted with lateral extension rods 75 slidably received within openings formed in corresponding posts 76 extending from support rails 77 of the rack 50. The extension rods 75 are fixedly displaceable by means of fixing bolts 78 whereby a respective support member 74 may be fixedly relocated to thereby set the distance between opposing support members.

Turning now to FIG. 2A, the elevator 60 is vertically displaceable within shaft 58 by means of an electric motor 66 fitted for displacing the elevator 60 along vertical support rails 68 between a plurality of collecting stations each corresponding with a front end 54 of a respective conveyor rack 50.

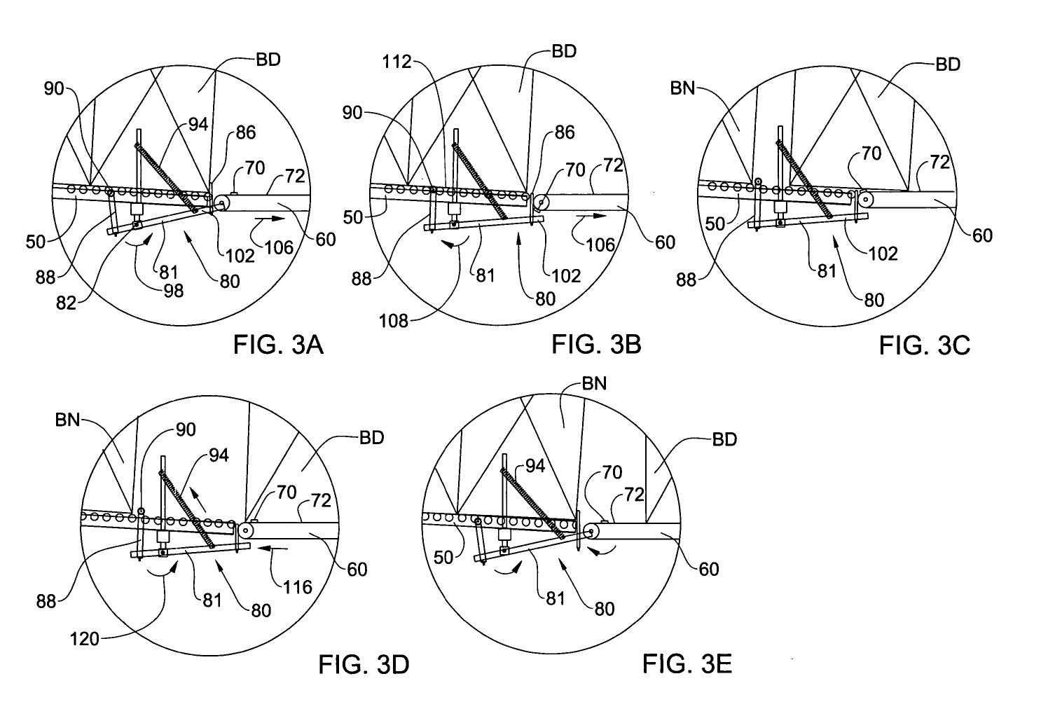

Elevator 60 comprises an elevator conveyor rack 72 suited for displacing boxes fed thereto between a rear position toward a front position adjacent the front wall 12 and optionally for displacing a box B toward the dispensing opening 20 once the elevator is at a dispensing level, as will become apparent hereinafter. The elevator conveyor rack 72 is a motorized conveyor fitted for displacement backwards and forwards for the reason to become apparent hereinafter and is further fitted with a toggle activating member 70 for activating a toggle assembly 80 associated with each conveyer rack 50, as will be explained in detail with reference to FIGS. 3A-3E.

Suitable control means are provided along the path of the elevator 60 within the shaft 58 for precisely stopping the elevator 60 opposite the front end 54 of each conveyor rack 50. Such means may be any sort of switches or sensors as known per se and the motor for displacement of the elevator 60 may be for example a step motor. Alternatively, the elevator 60 may be vertically displaceable along rotatable threaded rods as known per se.

Further attention is now directed to FIGS. 3A to 3E illustrating in a detailed manner the toggle assembly 80 for controlling displacement of a duty box from the conveyor rack 50 to the elevator 60, as will be apparent hereinafter with reference to the sequential drawings 3A-3E. The term duty box denotes a box B positioned at the front end of a respective conveyer rack and which is the box to be displaced to the elevator conveyer rack 72.

The toggle assembly 80 comprises a toggle member 81 pivotally secured to the conveyor rack 50 at 82 and comprising a front stopper 86 and a rear stopper 88, the latter provided with a roller 90 at its top end. The toggle assembly 80 is biased by coiled spring 94 to displace in a counter-clockwise direction as illustrated by arrow 98.

A front end 102 of the toggle member 81 projects in the direction of the elevator 60 positioned along the displacement path of toggle activating member 70 as will become apparent hereinafter. It is further noticed in FIG. 3A that in the normal state of the toggle member 81 the front stopper 86 projects above the conveyor rack and prevents forward displacement of the duty box BD.

Upon demand for a particular box B from a certain rack 50, the elevator 60 vertically displaces to a collecting position adjoining the respective rack 50 (FIG. 3A) and then the conveyor rack 72 of the elevator 60 rotates in the direction of arrow 108 (FIG. 3B) causing the toggle activating member 70 to contact the front end 102 of toggle member 81 to thereby pivotally displace the toggle member in the direction of arrow 108 (FIG. 3B). In this position, the roller 90 of the rear stopper 88 bears against a bottom surface 112 of the duty box BD whilst the front stopper 86 descends below the upper surface of the conveyor rack 50 whereby the duty box BD can now move towards the conveyor rack 72 of the elevator 60 (FIG. 3C). Simultaneously, the rear stopper 88 projects above the conveyor rack 50 for arresting the next in turn duty box BN.

As the duty box BD displaces toward the conveyor rack 72 of the elevator 60, the conveyor rack 72 rotates in an opposite direction as illustrated by arrow 116 (FIG. 3D) for removing the duty box BD from the conveyor rack 50 onto the elevator conveyor rack 72. Along with the displacement of the conveyor rack 72 the toggle activating member 70 displaces, allowing the toggle member 81 to displace back in the direction of arrow 120, permitting the next in turn duty box BN to ride over the roller 90 of the rear stopper arm 88 to then become arrested at the front end of the conveyor rack 50 by the front stopper 86 (FIG. 3E) ready for a next sequence of operation. At this stage the original duty box BD displaces along the conveyor rack 72 of the elevator 60 towards its front end whereby the elevator 60 then moves towards the dispensing station extending opposite the dispensing opening 20 formed in the front wall 12.

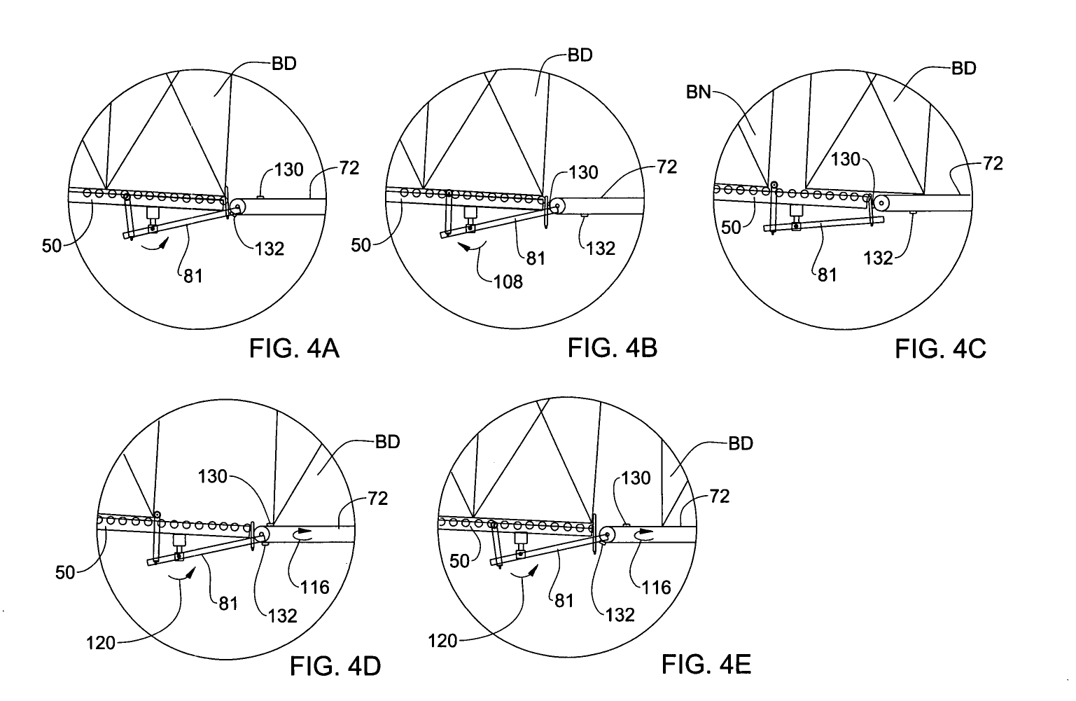

Further attention is now directed to FIGS. 4A-4E directed to a toggle assembly in accordance with a different embodiment of the present invention, represented by sequential drawings illustrating displacement of a duty box BD from the conveyor rack 50 to the elevator conveyor rack 60.

The embodiments of FIGS. 3A-3E and 4A-4E are principally similar and accordingly, similar elements appearing in FIGS. 4A-4E will be designated with same reference numerals as in corresponding FIGS. 3A-3E. The main difference between the two embodiments resides in that the latter embodiment lacks the biasing coiled spring 94 provide for biasing the toggle assembly in a counter-clockwise direction. Instead, the elevator conveyor rack 72 is fitted with two toggle activating members 130 and 132, the former fitted for cooperating similarly to the toggle activating member 70 as in the embodiment of FIGS. 3A-3E and in particular as disclosed in connection with FIGS. 3A-3C. The second toggle activating member 132 functions to replace the coiled spring 94 and cooperates with the toggle member 81 to displace it in a counter-clockwise direction as represented by arrow 120 in FIGS. 4D and 4E. This is facilitated by rotation of the elevator conveyor rack 72 in the direction of arrow 116 which simultaneously facilitates displacement of the original duty box BD over the elevator conveyor rack 72 to a forward position.

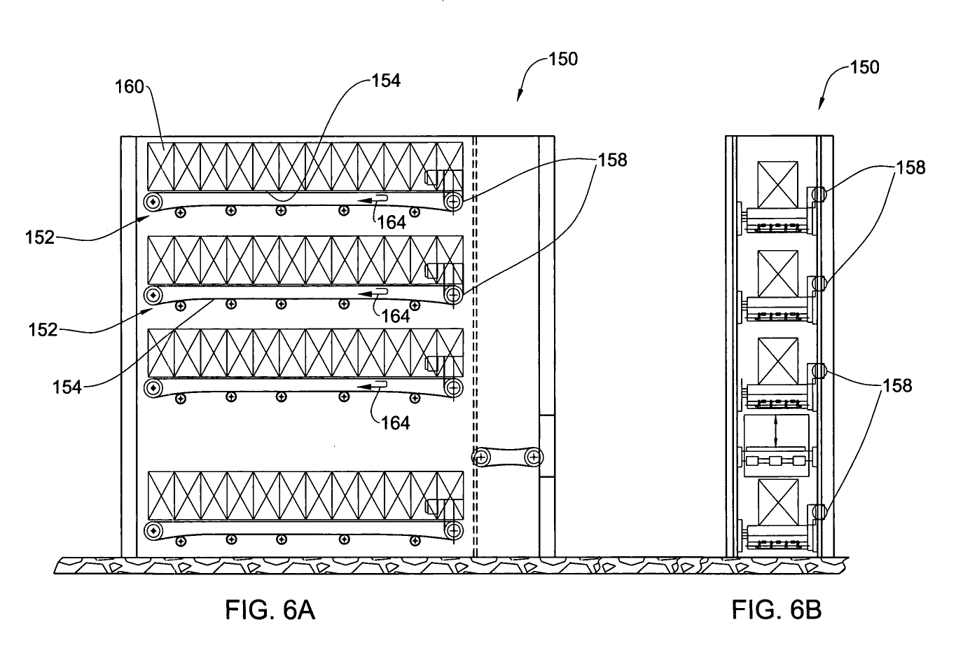

A different embodiment is inserted in FIGS. 6A and 6B illustrating a vending machine 150 which differs from the embodiment of FIG. 2 in that the conveyor racks 152 extend substantially horizontally and each such conveyor rack is fitted with a belt-type conveyor 154 driven by an independent electric motor 158 to facilitate displacement of boxes 160 in the direction from the rear end towards the front end, as illustrated by arrows 164. In this case, since the conveyor belts 152 are leveled, i.e. horizontal, there is no need to provide toggle means to ensure displacement of only one box at a time, as this is done by means of the motor 158 which is controlled by the control unit (not shown).

In accordance with a modification of the embodiment of FIGS. 6A and 6B, not shown, rather than providing an independent motor for each of the conveyors, there may be a single motor which by suitable transmission arrangements is engaged each time with a duty rack. Such transmission means are for example a linked chain, a gear transmission, etc.

Whilst particular embodiments have been described, it is to be understood that they are not intended thereby to limit the disclosure, but rather the disclosure is intended to cover all embodiments, modifications and arrangements falling within the spirit and the scope of the present invention, as defined in the appended claims, mutatis mutandis.

1. A vending machine comprising:
a cabinet having a front wall fitted with a dispensing opening;
a plurality of conveyer racks, parallely disposed within the cabinet, each for storing and conveying a plurality of boxes; each conveyer rack extending between a rear end adjacent a rear wall of the cabinet and a front end facing said front wall; and
an elevator assembly vertically displaceable along a path extending within the cabinet between the front ends of the conveyer racks and the front wall and being displaceable between a plurality of collecting stations adjacent each said front end and a vending station adjoining the dispensing opening.

2. A vending machine according to claim 1, wherein the conveyer racks are fitted with a box-displacing arrangement for displacing boxes in direction from the rear end toward the front end thereof.

3. A vending machine according to claim 2, wherein the box-displacing arrangement is a plurality of free-rolling members disposed along the conveyer rack and where the conveyer rack is inclined to facilitate gravitational displacement of the boxes towards the front end of the conveyer rack.

4. A vending machine according to claim 3, wherein the free rollers are a plurality of parallely extending roller members, their axis transversing the conveyer rack at a right angle.

5. A vending machine according to claim 1, wherein the conveyer racks are accessed for loading through a loading door at a rear portion of the cabinet.

6. A vending machine according to claim 1, wherein the boxes are displaceable over the conveyer racks by gravity force only.

7. A vending machine according to claim 1, wherein the conveyer racks are fitted with a displacement mechanism for displacing the boxes in direction from the rear end towards to the front end thereof.

8. A vending machine according to claim 7, wherein the convey racks extend substantially horizontally and wherein a motor is provided for displacing boxes in direction from the rear end towards the front end of each conveyor.

9. A vending machine according to claim 8, wherein each rack is fitted with a displacing motor.

10. A vending machine according to claim 8, wherein the conveyor racks are fitted with a conveyor belt engagable with a displacement motor.

11. A vending machine according to claim 1, wherein one or more of the conveyer racks are fitted with lateral support members to prevent lateral displacement of the boxes over the rack.

12. A vending machine according to claim 11, wherein the distance between opposite support members is adjustable for receiving boxes of different sizes.

13. A vending machine according to claim 12, wherein the support members are fitted with extension rods fixedly displaceable over support rails of the rack, whereby a respective support member may be fixedly relocated to thereby set the distance between the opposite support members.

14. A vending machine according to claim 13, wherein the support members are fitted with extension rods slidably received within openings formed in corresponding posts extending from support rails of the rack and wherein the extension rods are fixedly displaceable, whereby a respective support member may be fixedly relocated to thereby set the distance between the opposite support members.

15. A vending machine according to claim 1, wherein each conveyer rack is fitted at its front end with a toggle assembly to control displacement of a duty box from the conveyer rack.

16. A vending machine according to claim 15, wherein the toggle assembly is designed for releasing the duty box and simultaneously arresting the next in line box.

17. A vending machine according to claim 15, wherein the toggle assembly is activated by an activating member associated with the elevator.

18. A vending machine according to claim 1, wherein the elevator is fitted with an elevator conveyer rack for displacing a box between a rear end and a front end thereof.

19. A vending machine according to claim 18, wherein the elevator conveyer rack is activated by a motor.

20. A vending machine according to claim 15, wherein the elevator conveyor rack is fitted for traveling in a forward direction and in a reverse direction.

21. A vending machine according to claim 18, wherein the elevator conveyer rack comprises a member for activating a toggle assembly associated with each conveyer rack, to control displacement of a duty box from the conveyer rack.

22. A vending machine according to claim 21, wherein the elevator conveyer rack is fitted for traveling in an opposite, reverse direction, to allow for the member to activate the toggle assembly in two operative sequences, one to facilitate transfer of a duty box from the conveyer rack to the elevator and arrest the next box at a standby location over the conveyer rack; and a second to facilitate displacing of said next box from said standby location to a duty box location at the front end of the conveyer rack.

23. A vending machine according to claim 22, wherein the toggle assembly is fitted with a biasing spring arrangement for biasing a stopper arm of the toggle assembly into a position for arresting a duty box adjacent a front end of a conveyor.

24. A vending machine according to claim 22, wherein the elevator conveyor rack is fitted with two members for activating the toggle assembly, one displacing a front stopper member of the toggle assembly in a direction to disengage from a duty box and the other for displacing the front stopper in the direction to engage with a duty box adjacent a front end of the conveyor rack.

25. A vending machine according to claim 1, wherein the dispensing opening is openable only when the elevator extends opposite said dispensing opening.

26. A vending machine according to claim 25, wherein the dispensing opening is openable only when the elevator is loaded with a box.

27. A vending machine according to claim 1, wherein the dispensing opening is located at a height corresponding with the height of car boot.

28. A vending machine according to claim 1, wherein the dispensing opening is positioned at a height facilitating removal of a box while exerting minimal effort by a consumer.

29. A vending machine according to claim 1, wherein the dispensing opening enables withdrawal of a box by grabbing it at gripping openings formed at side walls of the box.

30. A vending machine according to claim 1, wherein the dispensing opening enables withdrawal of a box by grabbing it at a carrying handle formed at a tope wall of the box.

31. A vending machine according to claim 1, further comprising a control unit comprising a processor and a plurality of sensors within the cabinet for generating control signals responsive of functional parameters of the machine and quantity of boxes within the cabinet.

32. A vending machine according to claim 31, further comprising a user interface comprising a product selection module and a paying module.

33. A vending machine according to claim 32, wherein the control unit communicates with a remote control center.

34. A vending machine according to claim 34, wherein communication with the remote control center is facilitated by a wireless communication system.
